(19) United States
(12) Patent Application Publication
(10) Pub. No.: US 2024/0379091 A1
(43) Pub. Date: Nov. 14, 2024

(54) VOICE ASSISTANT APPLICATION FOR AUTOMATED VOICE RESPONSES BY LICENSED VOICES

(71) Applicant: Intrepid Services LLC, Alhambra, CA (US)

(72) Inventor: Michael WEED, Whittier, CA (US)

(73) Assignee: Intrepid Services LLC, Alhambra, CA (US)

(21) Appl. No.: 18/661,990

(22) Filed: May 13, 2024

Related U.S. Application Data
(60) Provisional application No. 63/501,725, filed on May 12, 2023.

(51) Int. Cl. G10L 13/033; G10L 15/00; G10L 15/18; G10L 15/22

(52) U.S. Cl. CPC G10L 13/033; G10L 15/005; G10L 15/1815; G10L 15/22

(57) ABSTRACT

A method is provided. The method is implemented by a voice assistant engine executed by a processor. The method includes receiving a voice input in a non-standardized form. The method includes generating a voice output responsive to the voice input by associating the voice input with an identification corresponding to a selected entity, determining a response to the voice input, and generating the voice output in a voice of the selected entity according to the response. The method includes outputting the voice output.

### BENEFIT CLAIM AND INCORPORATION BY REFERENCE

This application claims priority to U.S. Provisional Application No. 63/501,725, which was filed on May 12, 2023, and is incorporated herein by reference in its entirety.

### BACKGROUND

Conventional voice services enable a user to interact with a device. However, conventional voice services are limited to a generic male or generic female voices from responding the user. Thus, there is a need to enable/implement licensing personality likeness for interacting with users in daily life.

### SUMMARY

A method is provided according to one or more embodiments. The method includes receiving, by a voice assistant engine executed by one or more processors, a voice input in a non-standardized form; generating, by the voice assistant engine, a voice output responsive to the voice input by associating the voice input with an identification corresponding to a selected entity, determining a response to the voice input, and generating the voice output in a voice of the selected entity according to the response; and outputting, by the voice assistant engine, the voice output.

The method can be implemented as a device, a system, and a computer program product according to one or more embodiments.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 depicts a method according to one or more embodiments;

FIG. 2 depicts a diagram of a system according to one or more embodiments;

FIG. 3 depicts a diagram of a system according to one or more embodiments;

FIG. 4 depicts a network and a method performed in the network according to one or more embodiments; and

FIG. 5 depicts a diagram according to one or more embodiments.

### DETAILED DESCRIPTION

Disclosed herein is a voice assistant application that receives a voice input, utilizes content services to generate a script responsive to the voice input, implements voice cloning services that generate a voice output of a celebrity, a popular personality, or other entity according to the script, and provides the voice output. The voice assistant application is a processor executable code or software that is necessarily rooted in process operations by processing hardware. The voice assistant application can include a machine learning and/or artificial intelligence (“ML/AI”) as described herein.

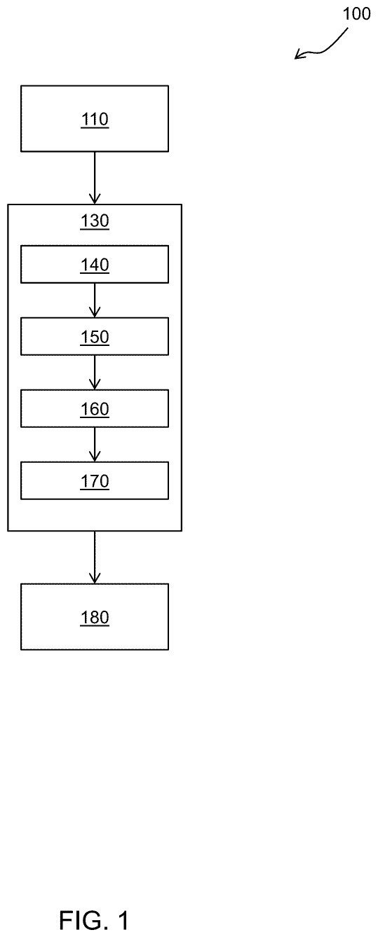

FIG. 1 illustrates a method 100 according to one or more embodiments. The method 100 is implemented by the voice assistant application. Generally, the voice assistant application can include response generation, voice cloning, and/or AI chatbot software that generates information based on a voice input and generates a voice output from the information.

The method begins at block 110, where the voice assistant application receives the voice input. The voice input can be received from a user through a microphone, a sensor, or other digital input of a device. The voice input can be received in a non-standardized form (e.g., no requirement for a particular number of words, syllables, characters, question or statement form, language, etc.). The voice input can be converted into a digital format.

The voice input can be accompanied by or associated with an identification corresponding to an entity of a plurality of entities. Each identification can be an alpha-numeric identifier unique to a particular entity. The identification can be selected automatically or by manual input prior to or contemporaneous with receiving the voice input. The entity can be a computer generated entity or a person. The person can be a celebrity, a popular personality, or other voice profile that has licensed a use of their unique voice to the voice assistant application. The voice assistant application can include pre-loaded voice samples of any entity. According to one or more embodiments, the voice assistant application can provide one or more subscription licenses, which are selectable or purchasable. Each subscription license corresponds to a computer generated entity or a person. Each subscription license includes the pre-loaded voice samples of the corresponding computer generated entity or person. Additionally/alternatively, each subscription license can be verified by an Advanced Encryption Standard with a 256-bit-key (AES-256).

According to one or more embodiments, a previous voice input or historical voice inputs can be processed by the voice assistant application with the voice input. The previous voice input can be a voice input from a prior point in time (e.g., minutes before, a same day, within past thirty (30) days, etc.). The historical voice inputs can be one or more voice inputs from a prior point in time, which include a trend or a pattern when these one or more voice inputs are processed together by the voice assistant application. Accordingly, the voice assistant application can maintain a conversational context from each previous input, across the historical voice inputs, and between the previous voice input and the historical voice inputs to the voice input received at block 110.

At block 130, the voice assistant application generates a voice output. The voice output can be responsive to the voice input. For instance, the voice assistant application processes the voice input to determine an intent and generate a response in the form of the voice output or automated voice response by a licensed voice. Accordingly, the voice assistant application processes the voice input that was received from the user in the non-standardized form to a standardized format of the voice output. Note that this standardized format of the voice output incorporates the intent of the voice output and is provided according to the subscription license (e.g., in the voice of a celebrity). A response (i.e., the voice output) can be an audio signal sent to the user's device speaker or speakers. Additionally/alternatively, a response (i.e., the voice output) can be a video signal sent to the user's device screen or screens. In processing the voice input, the voice assistant application can determine a language of the voice input to identify an expected language of the voice output. The voice assistant application can announce and/or display an error if the voice output is unable to be generated in the expected language output.

By way of example, at sub-block 140, the voice assistant application can implement natural-language processing (“NLP”) of the voice input. The NLP processing can transcribe the voice input into a text file or other data. According to one or more embodiments, the voice assistant application can include or connect to a NLP service. When connecting to the NLP service that is external to the voice assistant application, the voice assistant application can utilize a secure protocol, for example Transport Layer Security (TLS), Secure Sockets Layer (SSL) encryption, and/or an AES-256 that encrypts the voice input, text file, or other data to protect from interception.

Further, at sub-block 150, the voice assistant application generates a script responsive to the voice input. The NLP processing can utilize the text file or other data to provide a script responsive thereto. The script (i.e., a voice dialogue) can be based on pre-loaded voice samples.

At sub-block 160, the voice assistant application utilizes a response generation service (also referred to as a voice generation service endpoint). According to one or more embodiments, the response generation service checks an identification accompanied by or associated with the device or the user of the device. For example, the identification is a voice identifier used to match one of one or more subscription licenses and/or one or more entities (e.g., one or more licensed voices) to the voice input. Additionally/alternatively, the identification can be a voice identifier corresponding to a licensed voice selected by the user within the voice assistant application.

At sub-block 170, the voice assistant application utilizes voice cloning service. The voice cloning service generates a voice response in a digital format. According to one or more embodiments, the voice cloning service generates a voice response with the licensed voice in accordance with the script. For example, the voice cloning service generates a voice response of a celebrity that has licensed their voice and provided pre-loaded voice samples according to the script.

At block 180, the voice assistant application then outputs the voice response as the voice output. The voice response can be converted from a digital format to an audible sound. Outputting by the voice assistant application can include playing the voice output on at least one speaker of a device. Additionally/alternatively, the voice response can include an audio/video signal sent to the user's device. The voice output, thus, is the voice of the licensed celebrity chosen relative to block 110. Further, the voice assistant application generates accurate scripts and voice outputs from non-standardized voice inputs that otherwise are not available with conventional voice services.

One or more advantages, technical effects, and/or benefits of the voice assistant application can include providing comfort and novelty of having a familiar presence provide information and accessibility within a simplified configuration of the voice assistant application. In contrast, conventional voice services are not built to be used by common users through simplified interfaces while providing access to personalities that require authorization to use their likenesses. Thus, the voice assistant application particularly utilizes and transforms processing hardware to enable/implement licensing personality likeness with authorization for interacting with a device in daily life that is otherwise not currently available or currently performed by conventional voice services.

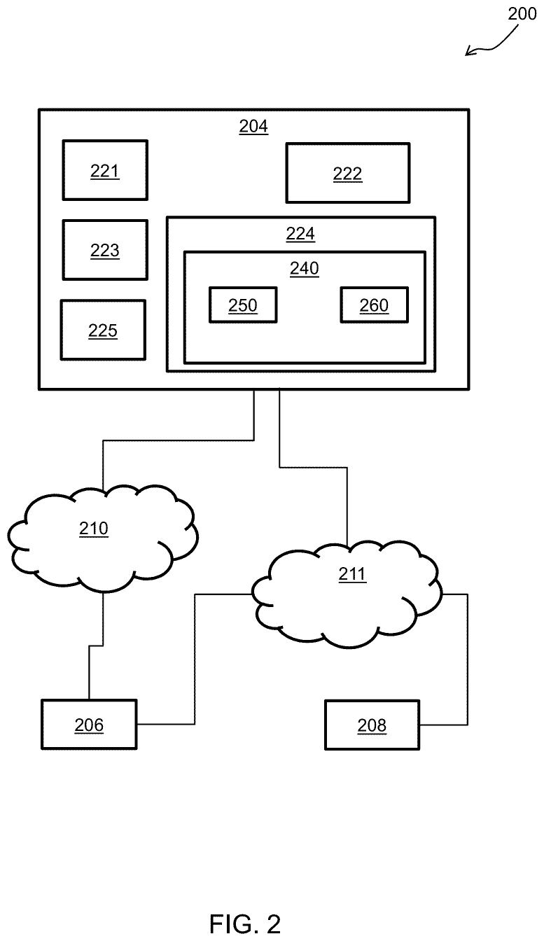

Turning now to FIG. 2, a diagram of a system 200 in which one or more features of the disclosure subject matter can be implemented is illustrated according to one or more exemplary embodiments. The system 200 includes a device 204, a first computing device 206, a second computing system 208, a first network 210, and a second network 211. Further, the device 204 can include an output component 221, a processor 222, a user input (UI) sensor 223, a memory 224, and a transceiver 225. The system 200 includes a voice assistant engine 240, which can further include a response generation service 250, a voice cloning service 260, and other services. The voice assistant engine 240 can be representative of the voice assistant application described herein.

Accordingly, the device 204, the first computing device 206, and/or the second computing system 208 can be programed to execute computer instructions with respect the voice assistant engine 240 and/or the services 250 and 260 (e.g., as a standalone software, in a client-server scheme, in a distributed computing architecture, as a cloud service platform, etc.). As an example, the memory 223 stores these instructions for execution by the processor 222 so that the device 204 can receive and process the voice input via the user input (UI) sensor 223. Note that the processor 222 and the memory 223 are representative of processors and memories of the first computing device 206 and/or the second computing system 208.

The device 204, the first computing device 206, and/or the second computing system 208 can be any combination of software and/or hardware that individually or collectively store, execute, and implement the voice assistant engine 240 and/or the services 250 and 260, and functions thereof. Further, the device 204, the first computing device 206, and/or the second computing system 208 can be an electronic, computer framework comprising and/or employing any number and combination of computing device and networks utilizing various communication technologies, as described herein. The device 204, the first computing device 206, and/or the second computing system 208 can be easily scalable, extensible, and modular, with the ability to change to different services or reconfigure some features independently of others.

The networks 210 and 211 can be a wired network, a wireless network, or include one or more wired and wireless networks. Transmissions between networks can be encrypted via a TLS protocol, a SSL, an AES-256, or other methods for securing data at rest and data in use. According to an embodiment, the network 210 is an example of a short-range network (e.g., local area network (LAN), or personal area network (PAN)). Information can be sent, via the network 210, between the device 204 and the first computing device 206 using any one of various short-range wireless communication protocols, for example Bluetooth, Wi-Fi, Zigbee, Z-Wave, near field communications (NFC), ultra-band, Zigbee, or infrared (IR). Further, the network 211 is an example of one or more of an Intranet, a local area network (LAN), a wide area network (WAN), a metropolitan area network (MAN), a direct connection or series of connections, a cellular telephone network, or any other network or medium capable of facilitating communication between the first computing device 206 and the second computing system 208. Information can be sent, via the network 211, using any one of various long-range wireless communication protocols (e.g., TCP/IP, HTTP, 3G, 4G/LTE, or 4G/New Radio). Note that for either network 210 and 211 wired connections can be implemented using Ethernet, Universal Serial Bus (USB), RJ-11 or any other wired connection and wireless connections can be implemented using Wi-Fi, WiMAX, and Bluetooth, infrared, cellular networks, satellite or any other wireless connection methodology.

In operation, the device 204 can obtain, monitor, store, process, and communicate via network 210 voice inputs, information, identifications, scripts, and voice outputs. Further, the device 204, the first computing device 206, and/or the second computing system 208 are in communication through the networks 210 and 211 (e.g., the first computing device 206 can be configured as a gateway between the device 204 and the second computing system 208). For instance, the device 204 can be configured to communicate with the first computing device 206 via the network 210. The first computing device 206 can be, for example, a stationary/standalone device, a base station, a desktop/laptop computer, a smart phone, a smartwatch, a tablet, or other local device configured to communicate with other devices via networks 211 and 210. The second computing system 208, implemented as a physical server on or connected to the network 211, as a virtual server in a public cloud computing provider (e.g., Amazon Web Services (AWS)® or Google Firebase®) of the network 211, or other remote devices, can be configured to communicate with the first computing device 206 via the network 211. Thus, the voice inputs, the information, the identifications, the scripts, and the voice outputs can be communicated throughout the system 200.

The processor 222, in executing the voice assistant engine 240, can be configured to receive, process, and manage the voice inputs acquired by the UI sensor 223, and communicate the voice inputs to the memory 224 for storage and/or across the network 210 via the transceiver 225. The voice inputs from one or more other apparatuses can also be received by the processor 222 through the transceiver 225.

According to one or more embodiments, the voice assistant engine 240 can include one or more application programming interfaces (APIs) or other endpoints to access a voice output, generate a voice output, process a variety of input parameters, and return a voice output. Additionally/alternative, any operational or processing aspects of the voice assistant engine 240 can be performed by discrete instances of code therein represented by the response generation service 250 and the voice cloning service 260. The voice assistant engine 240 can include an AI-based software application for mobile devices and web-based applications, for example a phone and a laptop (i.e., examples of the device 204). The voice assistant engine 240 can generate a voice output using as licensed voice of a celebrity or personality based in music, film, anime, video games, politics, and any other media or medium. The voice assistant engine 240 can be configured to store and recall user data and settings. The voice assistant engine 240 can be configured to customize the voice output with pitch, speed, and/or volume. The voice assistant engine 240 can be configured to provide voice recognition, natural language processing, and text-to-speech conversion, as well as other features. The voice assistant engine 240 can be configured to secure and protect user data.

The output component 221 includes and is representative of, for example, any device, transducer, speaker, touch screen, and/or indicator configured to provide outputs by audio, video, touching, etc. The output component 221 may include, for example, a speaker configured to convert one or more electrical signals into audible sounds.

The UI sensor 223 includes and is representative of, for example, any device, transducer, touch screen, and/or sensor configured to receive a user input by audio, video, touching, etc. The UI sensor 223 may include, for example, one or more transducers configured to convert one or more environmental conditions into an electrical signal, such that different types of audio are observed/obtained/acquired. The UI sensor 223 may include, for example, a touch screen interface integrated into a display (e.g., the output component 221).

The memory 224 is any non-transitory tangible media, for example magnetic, optical, or electronic memory (e.g., any suitable volatile and/or non-volatile memory, for example random-access memory or a hard disk drive). The memory 224 stores the computer instructions for execution by the processor 222.

The transceiver 225 may include a separate transmitter and a separate receiver. Alternatively, the transceiver 225 may include a transmitter and receiver integrated into a single device. The transceiver 225 enables communication with other software and components of the system 200.

In operation, the system 200, utilizing the voice assistant engine 240 and other software and components therein, generates a script responsive to a voice input, implements voice cloning services that generate a voice output of a celebrity, a popular personality, or other entity according to the script, and provides a voice output. For example, the device 204 utilizes the memory 224, and shares portions and/or all information across the system 200 via the transceiver 225 to implement the operations of the system. The operations of the system 200, for example the operations of the voice assistant engine 240, can includes utilizing models, neural networks, AI chatbot software, and/or ML/AI that generate information based on a voice input and generate a voice output from the information.

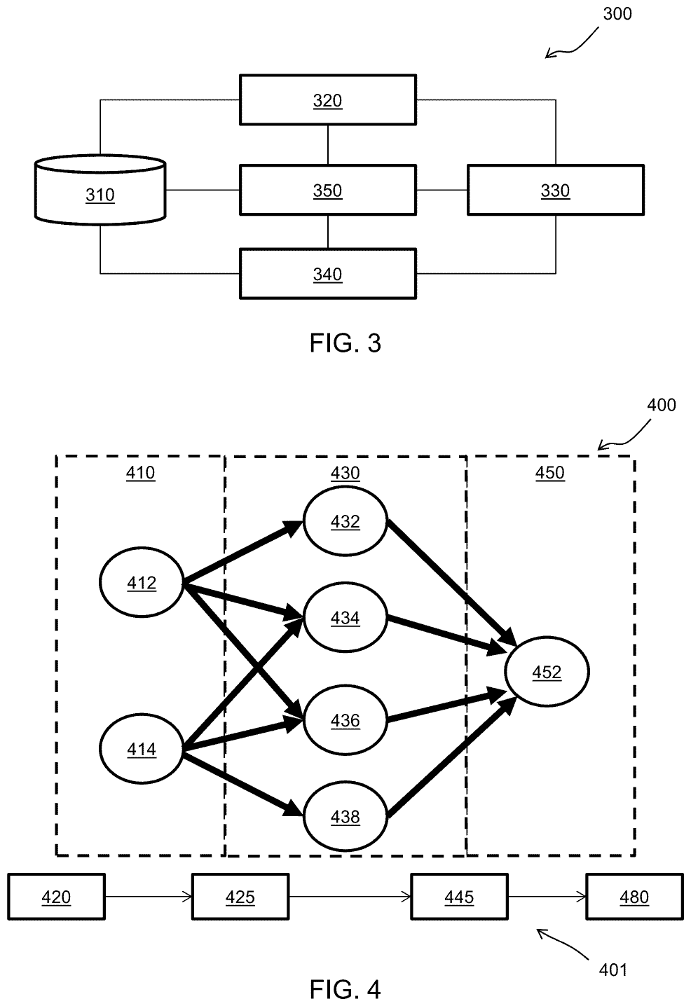

FIG. 3 illustrates a graphical depiction of a system 300 according to one or more embodiments. As shown, the system 300 includes data 310 (e.g., voice inputs, information, identifications, scripts, and voice outputs) that can be stored on a memory or other storage unit. Further, the system 300 includes a machine 320 and a model 330, which represent software aspects of the voice assistant engine 240 of FIGS. 1-2 (e.g., ML/AI therein). The machine 320 and the model 330 together can generate an outcome 330.

The description of FIGS. 3-4 is made with reference to FIGS. 1-2 for ease of understanding where appropriate. The system 300 can include hardware 350, which can represent the devices 204, the first computing device 206, and the second computing system 208 of FIG. 2. In general, the ML/AI of the system 300 (e.g., as implemented by the voice assistant engine 240 of FIGS. 1-2) operate with respect to the hardware 350, using the data 310, to train the machine 320, build the model 330, and predict the outcomes 330.

For instance, the machine 320 operates as software controller executing on the hardware 350. The data 310 can be on-going data (i.e., data that is being continuously collected) or output data associated with the hardware 350. The data 310 can also include currently collected data, historical data, or other data from the hardware 350 and can be related to the hardware 350. The data 310 can be divided by the machine 320 into one or more subsets.

Further, the machine 320 trains, which can include an analysis and correlation of the data 310 collected. In accordance with another embodiment, training the machine 320 can include self-training by the voice assistant engine 240 of FIG. 1 utilizing the one or more subsets. In this regard, for example, the voice assistant engine 240 of FIG. 1 learns to process and generate voice inputs and outputs.

Moreover, the model 330 is built on the data 310. Building the model 330 can include physical hardware or software modeling, algorithmic modeling, and/or other model that seeks to represent the data 310 (or subsets thereof) that has been collected and trained. In some aspects, building of the model 330 is part of self-training operations by the machine 320. The model 330 can be configured to model the operation of hardware 350 and model the data 310 collected from the hardware 350 to predict the outcome 330 achieved by the hardware 350. Predicting the outcomes 330 (of the model 330 associated with the hardware 350) can utilize a trained model 330.

Thus, for the system 300 to operate as described, the ML/AI algorithms therein can include neural networks. In general, a neural network is a network or circuit of neurons, or in a modern sense, an artificial neural network (ANN), composed of artificial neurons or nodes or cells.

For example, an ANN involves a network of processing elements (artificial neurons) which can exhibit complex global behavior, determined by the connections between the processing elements and element parameters. These connections of the network or circuit of neurons are modeled as weights. A positive weight reflects an excitatory connection, while negative values mean inhibitory connections. Inputs are modified by a weight and summed using a linear combination. An activation function may control the amplitude of the output. For example, an acceptable range of output is usually between 0 and 1, or it could be −1 and 1. In most cases, the ANN is an adaptive system that changes its structure based on external or internal information that flows through the network.

In more practical terms, neural networks are non-linear statistical data modeling or decision-making tools that can be used to model complex relationships between inputs and outputs or to find patterns in data. Thus, ANNs may be used for predictive modeling and adaptive control applications, while being trained via a dataset. Note that self-learning resulting from experience can occur within ANNs, which can derive conclusions from a complex and seemingly unrelated set of information. The utility of artificial neural network models lies in the fact that they can be used to infer a function from observations and also to use it. Unsupervised neural networks can also be used to learn representations of the input that capture the salient characteristics of the input distribution, and more recently, deep learning algorithms, which can implicitly learn the distribution function of the observed data. Learning in neural networks is particularly useful in applications where the complexity of the data (e.g., the data 310) or task (e.g., processing and generating voice inputs and outputs) makes the design of such functions by hand impractical.

For the system 300, the ML/AI algorithms therein can include neural networks that are divided generally according to tasks to which they are applied. These divisions tend to fall within the following categories: regression analysis (e.g., function approximation) including time series prediction and modeling; classification including pattern and sequence recognition; novelty detection and sequential decision making; data processing including filtering; clustering; blind signal separation, and compression.

According to one or more embodiments, the neural network can implement a long short-term memory neural network architecture, a convolutional neural network (CNN) architecture, or other network. The neural network can be configurable with respect to a number of layers, a number of connections (e.g., encoder/decoder connections), a regularization technique (e.g., dropout); and an optimization feature.

The long short-term memory neural network architecture includes feedback connections and can process single data points (e.g., images), along with entire sequences of data (e.g., speech or video). A unit of the long short-term memory neural network architecture can be composed of a cell, an input gate, an output gate, and a forget gate, where the cell remembers values over arbitrary time intervals and the gates regulate a flow of information into and out of the cell.

The CNN architecture is a shared-weight architecture with translation invariance characteristics where each neuron in one layer is connected to all neurons in the next layer. The regularization technique of the CNN architecture can take advantage of the hierarchical pattern in data and assemble more complex patterns using smaller and simpler patterns. If the neural network implements the CNN architecture, other configurable aspects of the architecture can include a number of filters at each stage, kernel size, a number of kernels per layer.

Turning now to FIG. 4, an example of a neural network 400 and a block diagram of a method 401 performed in the neural network 400 are shown according to one or more embodiments. The neural network 400 operates to support implementation of the ML/AI (e.g., as implemented by the voice assistant engine 240 of FIGS. 1-2) described herein. The neural network 400 can be implemented in hardware, for example the machine 320 and/or the hardware 350 of FIG. 3. As indicated herein, the description of FIGS. 3-4 is made with reference to FIGS. 1-3 for ease of understanding where appropriate.

In an example operation, the voice assistant engine 240 of FIG. 1 includes collecting the data 310 from the hardware 350. In the neural network 400, an input layer 410 is represented by a plurality of inputs (e.g., inputs 412 and 414 of FIG. 4). With respect to block 420 of the method 401, the input layer 410 receives the inputs 412 and 414. The inputs 412 and 414 can include the data 310. For example, the collecting of the data 310 can be an aggregation of the data 310, from one or more recordings of the hardware 350 into a dataset (as represented by the data 310).

At block 425 of the method 401, the neural network 400 encodes the inputs 412 and 414 utilizing any portion of the data 310 (e.g., the dataset and predictions produced by the system 300) to produce a latent representation or data coding. The latent representation includes one or more intermediary data representations derived from the plurality of inputs. According to one or more embodiments, the latent representation is generated by an element-wise activation function (e.g., a sigmoid function or a rectified linear unit) of the voice assistant engine 240 of FIG. 1. As shown in FIG. 4, the inputs 412 and 414 are provided to a hidden layer 430 depicted as including nodes 432, 434, 436, and 438. The neural network 400 performs the processing via the hidden layer 430 of the nodes 432, 434, 436, and 438 to exhibit complex global behavior, determined by the connections between the processing elements and element parameters. Thus, the transition between layers 410 and 430 can be considered an encoder stage that takes the inputs 412 and 414 and transfers it to a deep neural network (within layer 430) to learn some smaller representation of the input (e.g., a resulting the latent representation).

The deep neural network can be a CNN, a long short-term memory neural network, a fully connected neural network, or combination thereof. The inputs 412 and 414 can be voice inputs as described herein. This encoding provides a dimensionality reduction of the inputs 412 and 414. Dimensionality reduction is a process of reducing the number of random variables (of the inputs 412 and 414) under consideration by obtaining a set of principal variables. For instance, dimensionality reduction can be a feature extraction that transforms data (e.g., the inputs 412 and 414) from a high-dimensional space (e.g., more than 10 dimensions) to a lower-dimensional space (e.g., 2-3 dimensions). The technical effects and benefits of dimensionality reduction include reducing time and storage space requirements for the data 310, improving visualization of the data 310, and improving parameter interpretation for ML. This data transformation can be linear or nonlinear. The operations of receiving (block 420) and encoding (block 425) can be considered a data preparation portion of the multi-step data manipulation by the voice assistant engine 240.

At block 445 of the method 410, the neural network 400 decodes the latent representation. The decoding stage takes the encoder output (e.g., the resulting the latent representation) and attempts to reconstruct some form of the inputs 412 and 414 using another deep neural network. In this regard, the nodes 432, 434, 436, and 438 are combined to produce in the output layer 450 an output 452, as shown in block 460 of the method 410. That is, the output layer 490 reconstructs the inputs 412 and 414 on a reduced dimension but without the signal interferences, signal artifacts, and signal noise. Examples of the output 452 include cleaned data 310 (e.g., clean/denoised version of voice outputs or other output). The technical effects and benefits of the cleaned data 310 include enabling more accurate user experience with respect to the voice outputs (e.g., the voice assistant engine 240 generates accurate scripts and voice outputs from non-standardized voice inputs that otherwise are not available with conventional voice services).

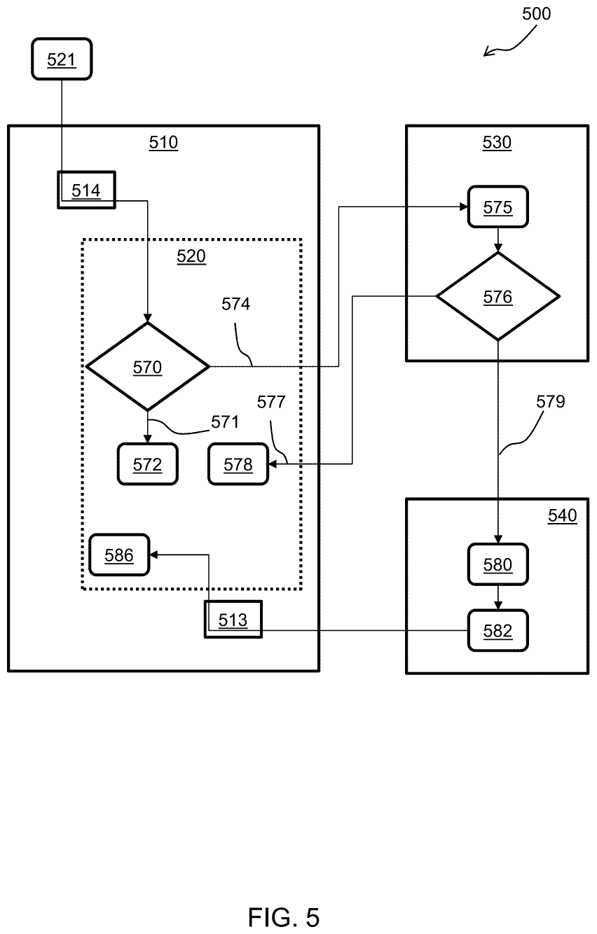

FIG. 5 depicts a diagram of a system 500 according to one or more exemplary embodiments. The system 500 illustrates a user device 510 with examples including a phone and a laptop as connected devices. The connected devices can include a speaker 513 and a microphone 514. The system 500 illustrates a legend assistant application 520, which is an example of the voice assistant engine 240. The legend assistant application 520 can receive a user input 521. The user input 521 can be a voice input. As shown in FIG. 5, a user input 521 can be received via the microphone 514 of the device 510 by the legend assistant application 520. An example of the user input 521 can include “What is the weather today?”.

The legend assistant application 520 can include one or more application programming interfaces (APIs) or other endpoints to access online services and control the connected devices and/or to operate in conjunction with other applications, software, and code of the device 510 (to receive and process the user input 521). These APIs and all subsequent transmissions between devices and networks can employ encryption security protocols, for example TLS, SSL, AES-256, or other methods to safeguard data integrity and confidentiality during transmission. The online services can include a response generation service 530, which can be representative of the response generation service 250 and other services described herein. The response generation service 530 can be hosted on a device external to the user device 510 and connected over a network as described herein. The online services can include a voice cloning service 540, which can be representative of the voice cloning service 260 and other services described herein. The voice cloning service 540 can be hosted on a device external to the user device 510 and connected over a network as described herein. The legend assistant application 520 can utilize encryption and other security measures to protect data transferring between elements of the system 500.

At decision block 570, the legend assistant application 520 determines if the user input 521 requires a response. A response can be an voice audio signal generated as a result of the user's input being sent to a processing service to identify the user's request. If the user input 521 does not require a response, the legend assistant application 520 proceeds (as shown by arrow 571) to block 572 to terminate operations respective to the user input 521. If the user input 521 does not require a response, the legend assistant application 520 proceeds (as shown by arrow 574) to communicate with the response generation service 530. According to one or more embodiments, the legend assistant application 520 can access one or more third-party services to provide a response relevant to the user input 521. Examples of third-party services includes, but are not limited to ElevenLabs, ChatGPT, OpenWeather, Google Maps, and Open Exchange Rates.

According to one or more embodiments, the legend assistant application 520 communicates with the response generation service 530 to use Natural Language Processing (NLP) to identify and respond to an intent within the user input 521. The communication between the legend assistant application 520 and the response generation service 530 can be encrypted by TLS, SSL, AES-256, or other methods to safeguard data integrity and confidentiality during transmission. The legend assistant application 520 can communicate the user input 521 in a request to the response generation service 530. The request can include the user input 521 accompanied by or associated with an identification (e.g., a voice identifier corresponding to a licensed voice).

By way of example, if the legend assistant application 520 determines that the user input 521 requires the response, the legend assistant application 520 can determine the licensed voice assigned for use based on a voice identifier. The legend assistant application 520 can determine/check an identification (e.g., the voice identifier) accompanied by or associated with the device or the user of the device (e.g., match the user input 521 to a selected one of one or more subscription licenses and/or one or more entities within the legend assistant application 520). Additionally/alternatively, the identification can be a voice identifier corresponding to a licensed voice selected by the user within the voice assistant application. The legend assistant application 520 can, next, package the user input 521 with the voice identifier in the request. The request can be sent to the response generation service 530.

At block 575, the response generation service 530 receives the request. At decision block 576, the response generation service 530 performs a determination of the request. The determination of the request can include performing NPL to generate a natural response. The natural response can be generated with respect to the user input 521 of the request and can include a script. For instance, the natural response can be analyzed by the response generation service 530 to determine validity in view of the user input 521 (e.g., whether the script be generated in a desired language).

If the response generation service 530 determines that the natural response is invalid, the response generation service 530 proceeds (as shown by arrow 577) to communicate an error to the user device 510. At block 578, the user device 510 receives the error. The error details can contain technical information that may be processed by the legend assistant application 520 to provide end-user friendly alerts, notifications, or messages that include content or context of the error. The legend assistant application 520 can also provide suggestions for resolving the error.

If the response generation service 530 determines that the natural response is valid, the response generation service 530 proceeds (as shown by arrow 579) to communicate with the voice cloning service 540. The response generation service 530 can communicate the natural response, the request, the user input 521, the voice identifier, or any combination thereof to the voice cloning service 540.

The voice cloning service 540 can receive the natural response, the request, the user input 521, the voice identifier, or any combination thereof from the response generation service 530. At block 580, the voice cloning service 540 performs a lookup operation with respect to the voice identifier supplied to the response generation service 530 (included at arrow 574). The lookup operation identifies a licensed voice from the voice identifier.

At block 582, the voice cloning service 540 performs a voice generation using the identified licensed voice (e.g., generates an automated voice response by a licensed voice). The voice cloning service 540 accesses a specific voice profile associated with the voice identifier. Additionally/alternatively, the specific voice profile contains predefined characteristics, for example tone, pitch, and modulation, which are essential for recreating distinctive features of the identified licensed voice. Additionally/alternatively, the specific voice profile contains pre-loaded voice samples of the identified licensed voice. The voice generation provides a voice output (e.g., a voice generated response) from the specific voice profile.

The voice cloning service 540 can communicate the voice output to the legend assistant application 520. Then, at block 586, the legend assistant application 520 causes the speaker 513 to output the voice output from block 582. The legend assistant application 520 can operate in conjunction with other applications, software, and code of the device 510 to provide the voice output within the operations of those applications, software, and code.

According to one or more embodiments, a method is provided. The method includes receiving, by a voice assistant engine executed by one or more processors, a voice input. The method includes generating a script responsive to the voice input and outputting a voice output utilizing the script by the voice assistant engine. Additionally/alternatively, the voice assistant engine can utilize content services to generate the script. Additionally/alternatively, the voice assistant engine can utilize voice cloning services to generate the voice output utilizing a voice of an entity. Additionally/alternatively, the entity can be a person or being, whether real or fictional. Additionally/alternatively, the voice assistant engine can receive an identification corresponding to an entity.

According to one or more embodiments, a method is provided. The method includes receiving, by a voice assistant engine executed by one or more processors, a voice input in a non-standardized form; generating, by the voice assistant engine, a voice output responsive to the voice input by associating the voice input with an identification corresponding to a selected entity, determining a response to the voice input, and generating the voice output in a voice of the selected entity according to the response; and outputting, by the voice assistant engine, the voice output. Additionally/alternatively, the voice assistant engine can utilize voice cloning services to generate the voice output utilizing the voice of the selected entity. Additionally/alternatively, the voice cloning service can access a specific voice profile associated with a voice identifier of the selected entity and the specific voice profile can include predefined characteristics or pre-loaded voice samples of a licensed voice of the selected entity. Additionally/alternatively, the voice assistant engine can receive the voice input from a user through a microphone of a device and outputs the voice output through a speaker of the device. Additionally/alternatively, the voice assistant engine can process the voice input to determine an intent of the voice input and generate the response. Additionally/alternatively, the voice assistant engine can process the voice input to determine a language of the voice input to identify an expected language of the voice output. Additionally/alternatively, the selected entity can be a celebrity or a popular personality licensed by the voice assistant engine. Additionally/alternatively, the voice assistant engine can process the voice input with a previous voice input or one or more historical voice inputs to maintain a conversational context for the voice output. Additionally/alternatively, the voice assistant engine can process the voice input using natural-language processing to transcribe the voice input into a text file and generate a script responsive to the voice input from the text file as the response. Additionally/alternatively, the selected entity can be identified by a voice identifier used to match the voice input to one or more subscription licenses or one or more entities

According to one or more embodiments, a computer program product for a voice assistant engine is provided. The computer program product is stored on a non-transitory computer readable medium. The computer program product is executable by executed one or more processors to cause operations comprising receiving, by the voice assistant engine, a voice input in a non-standardized form; generating, by the voice assistant engine, a voice output responsive to the voice input by associating the voice input with an identification corresponding to a selected entity, determining a response to the voice input, and generating the voice output in a voice of the selected entity according to the response; and outputting, by the voice assistant engine, the voice output. Additionally/alternatively, the voice assistant engine can utilize voice cloning services to generate the voice output utilizing the voice of the selected entity. Additionally/alternatively, the voice cloning service can access a specific voice profile associated with a voice identifier of the selected entity and the specific voice profile can include predefined characteristics or pre-loaded voice samples of a licensed voice of the selected entity. Additionally/alternatively, the voice assistant engine can receive the voice input from a user through a microphone of a device and outputs the voice output through a speaker of the device. Additionally/alternatively, the voice assistant engine can process the voice input to determine an intent of the voice input and generate the response. Additionally/alternatively, the voice assistant engine can process the voice input to determine a language of the voice input to identify an expected language of the voice output. Additionally/alternatively, the selected entity can be a celebrity or a popular personality licensed by the voice assistant engine. Additionally/alternatively, the voice assistant engine can process the voice input with a previous voice input or one or more historical voice inputs to maintain a conversational context for the voice output. Additionally/alternatively, the voice assistant engine can process the voice input using natural-language processing to transcribe the voice input into a text file and generate a script responsive to the voice input from the text file as the response. Additionally/alternatively, the selected entity can be identified by a voice identifier used to match the voice input to one or more subscription licenses or one or more entities

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. A computer readable medium, as used herein, is not to be construed as being transitory signals per se, for example radio waves or other freely propagating electromagnetic waves, electromagnetic waves propagating through a waveguide or other transmission media (e.g., light pulses passing through a fiber-optic cable), or electrical signals transmitted through a wire

Examples of computer-readable media include electrical signals (transmitted over wired or wireless connections) and computer-readable storage media. Examples of computer-readable storage media include, but are not limited to, a register, cache memory, semiconductor memory devices, magnetic media (for example internal hard disks and removable disks), magneto-optical media, optical media (for example compact disks (CD) and digital versatile disks (DVDs)), a random access memory (RAM), a read-only memory (ROM), an erasable programmable read-only memory (EPROM or Flash memory), a static random access memory (SRAM), and a memory stick. A processor in association with software may be used to implement a radio frequency transceiver for use in a terminal, base station, or any host computer.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving, by a voice assistant engine executed by one or more processors, a voice input in a non-standardized form;
generating, by the voice assistant engine, a voice output responsive to the voice input by associating the voice input with an identification corresponding to a selected entity, determining a response to the voice input, and generating the voice output in a voice of the selected entity according to the response; and
outputting, by the voice assistant engine, the voice output.

2. The method of claim 1, wherein the voice assistant engine utilizes voice cloning services to generate the voice output utilizing the voice of the selected entity.

3. The method of claim 2, wherein the voice cloning service accesses a specific voice profile associated with a voice identifier of the selected entity, the specific voice profile including predefined characteristics or pre-loaded voice samples of a licensed voice of the selected entity.

4. The method of claim 1, wherein the voice assistant engine receives the voice input from a user through a microphone of a device and outputs the voice output through a speaker of the device.

5. The method of claim 1, wherein the voice assistant engine processes the voice input to determine an intent of the voice input and generate the response.

6. The method of claim 1, wherein the voice assistant engine processes the voice input to determine a language of the voice input to identify an expected language of the voice output.

7. The method of claim 1, wherein the selected entity comprises a celebrity or a popular personality licensed by the voice assistant engine.

8. The method of claim 1, wherein the voice assistant engine processes the voice input with a previous voice input or one or more historical voice inputs to maintain a conversational context for the voice output.

9. The method of claim 1, wherein the voice assistant engine processes the voice input using natural-language processing to transcribe the voice input into a text file and generate a script responsive to the voice input from the text file as the response.

10. The method of claim 1, wherein the selected entity is identified by a voice identifier used to match the voice input to one or more subscription licenses or one or more entities.

11. A computer program product for a voice assistant engine, the computer program product being stored on a non-transitory computer readable medium, and the computer program product being executable by executed one or more processors to cause operations comprising:
receiving, by the voice assistant engine, a voice input in a non-standardized form;
generating, by the voice assistant engine, a voice output responsive to the voice input by associating the voice input with an identification corresponding to a selected entity, determining a response to the voice input, and generating the voice output in a voice of the selected entity according to the response; and
outputting, by the voice assistant engine, the voice output.

12. The computer program product of claim 11, wherein the voice assistant engine utilizes voice cloning services to generate the voice output utilizing the voice of the selected entity.

13. The computer program product of claim 12, wherein the voice cloning service accesses a specific voice profile associated with a voice identifier of the selected entity, the specific voice profile including predefined characteristics or pre-loaded voice samples of a licensed voice of the selected entity.

14. The computer program product of claim 11, wherein the voice assistant engine receives the voice input from a user through a microphone of a device and outputs the voice output through a speaker of the device.

15. The computer program product of claim 11, wherein the voice assistant engine processes the voice input to determine an intent of the voice input and generate the response.

16. The computer program product of claim 11, wherein the voice assistant engine processes the voice input to determine a language of the voice input to identify an expected language of the voice output.

17. The computer program product of claim 11, wherein the selected entity comprises a celebrity or a popular personality licensed by the voice assistant engine.

18. The computer program product of claim 11, wherein the voice assistant engine processes the voice input with a previous voice input or one or more historical voice inputs to maintain a conversational context for the voice output.

19. The computer program product of claim 11, wherein the voice assistant engine processes the voice input using natural-language processing to transcribe the voice input into a text file and generate a script responsive to the voice input from the text file as the response.

20. The computer program product of claim 11, wherein the selected entity is identified by a voice identifier used to match the voice input to one or more subscription licenses or one or more entities.
